(19) United States
(12) Patent Application Publication
(10) Pub. No.: US 2022/0180309 A1
(43) Pub. Date: Jun. 9, 2022

(54) Integrated Asset Tracking System and Method

(71) Applicant: The Burtner Group, LLC, Burnsville, NC (US)

(72) Inventors: Richard Lee Burtner, Burnsville, NC (US); Robert Anderson, Brentwood, TN (US)

(73) Assignee: The Burtner Group, LLC, Burnsville, NC (US)

(21) Appl. No.: 17/476,504

(22) Filed: Sep. 16, 2021

Related U.S. Application Data
(60) Provisional application No. 63/053,266, filed on Jul. 17, 2020.

(51) Int. Cl. G06Q 10/08; G06F 3/14; H04W 4/021; H04W 4/80; G01S 19/01; G01K 13/00

(52) U.S. Cl. CPC G06Q 10/0833; G06F 3/14; H04W 4/021; G01K 13/00; G06Q 10/087; G01S 19/01; H04W 4/80

(57) ABSTRACT

Disclosed herein are systems and methods for tracking high value inventory during both the shipping and storage stages. The system is comprised of sensors that attach to the items of inventory and which are then tracked using mesh networks and the global positioning system.

### CROSS REFERENCE TO RELATED APPLICATION

This application claims priority to U.S. Provisional Patent Application No. 63/053,266 filed Jul. 17, 2020.

### FIELD

This document relates to devices, systems, and methods for the management of inventory.

### BACKGROUND

Despite technological advances, inventory management remains a challenge to operations and retail. This can be particularly problematic with assets involved in high value operations. An example of this is in the hospital setting, where lack of access to life-saving equipment can sacrifice patient health and significant revenue for the hospital.

Various methods for tracking delivery trucks exist in the art but each of these fail to seamlessly continue tracking the asset during delivery and after the asset has been delivered.

Harnessing RFID technology is a popular approach to inventory management. However, it is not practical to know the location of an asset at all times and at all points in the supply chain after the asset leaves its port of manufacture up until the asset is disposed by the owner.

### SUMMARY

In an embodiment described herein, a system and method for asset tracking is provided. An asset tracking system comprising a centralized computing device configured to receive data from one or more tracking sensors wherein receiving data includes receiving location information from one or more gateways the one or more gateways configured to form an optimized mesh network with a plurality of nodes, the plurality of nodes and the one or more gateways configured to track the one or more tracking sensors, the one or more tracking sensors each having a global positioning system (GPS) receiver, a radio receiver, cellular transmitter, and a radio transmitter, and are configured to attach to an asset, an interface in communication with the centralized computing device configured to display location data for any one or more of the one or more sensors, an adjustable geofence module configured to create a perimeter around a destination for the asset, wherein the perimeter can be adjusted via the network interface. The centralized computing device is capable of receiving data from the sensors seamlessly throughout the supply chain including GPS and mesh networks.

In another embodiment the gateway is configured to communicate with ethernet, wifi, and cellular networks. The gateway can both transmit and receive data from other gateways.

In another embodiment the one or more tracking sensors are configured to send data that includes a temperature of the tracking sensor. This allows for vital information to be known about an asset, such as when the asset is a vaccine that has specific temperature requirements for safe use.

In another embodiment the interface is configured to accept queries from a user and communicate with the centralized computing device to respond to such queries. The interface can be a touch screen and it can show the location of any asset connected to a tracking sensor. When the tracking sensor is inside the building and communicating with the nodes and gateways, the user can determine the floor that a particular tracking sensor and asset are located as the nodes and gateways can triangulate a location. The user can also receive other data regarding the asset, such as temperature or other sensor readings. The user can also submit queries regarding various time stamps that the tracking sensor has, such as when the tracking sensor and asset left a warehouse or when it reached a destination such as a hospital.

In another embodiment the adjustable geofence can be monitored by GPS or the mesh network. The user can use the interface to adjust the perimeter of the geofence. The geofence is generally set up to track the perimeter of the destination building so that a user will be able to determine when a tracking sensor and asset arrive at a building, for example.

In another embodiment the plurality of nodes communicate with others of the plurality of nodes that are within a range creating a mesh network with the gateways. Nodes on adjacent floors can communicate with one another.

In another embodiment the radio receiver and the radio transmitter operate at a radio frequency that is compatible with Bluetooth low energy mesh systems and wife. In the preferred embodiment, the mesh networks are Bluetooth low energy.

In another embodiment the tracking sensors further comprise a memory module configured for storing data. This allows data to be determined about a tracking sensor retroactively.

Also disclosed is an asset tracking system comprising: a centralized computing system, one or more gateways configured to communicate with one or more nodes, a plurality of tracking sensors, and the centralized computing system, the plurality of tracking sensors further comprising a module configured to receive GPS signals, a module configured to receive radio signals, preferably at 2.4 GHz, a module configured to transmit radio signals the radio signals, preferably at 2.4 GHz, and a module configured to transmit cellular signals to the centralized computing system an interface for showing a location for any one of the plurality of tracking sensors. When the tracking sensors are within range of both a 2.4 GHz and GPS and cellular, the tracking sensors will switch to 2.4 GHz. The 2.4 GHz radio frequency is for Bluetooth low energy mesh networks and wife.

In another embodiment the interface can receive a query with a question regarding the data acquired from a tracking sensor and return a response to the query. Such queries can regard the location of the tracking sensor while the tracking sensor is in route using GPS or inside when the tracking sensor is inside a building and connected to a Bluetooth low energy mesh network. Such queries can also include locations at specific times saved as time stamps as well as information from other sensors. These tracking sensors may optionally have temperature sensors, oxygen concentration sensors, other gas detection, or materials in the gas, such as viruses.

In another embodiment the gateway is configured to communicate with wife, ethernet, and cellular networks. It can also communicate using Bluetooth.

In another embodiment the plurality of tracking sensors are configured to stick to an asset. Preferably, the side that sticks to the asset is flat. The side that sticks could also be soft so that it conforms to the asset. It can be stuck using an adhesive, magnet, or other form known in the art.

Also disclosed herein is a computer implemented method for tracking one or more assets, the method comprising: using a centralized computing system to receive cellular or internet data from one or more gateways and a plurality of tracking sensors, the plurality of tracking sensors configured to communicate the data to a mesh network of one or more nodes and the one or more gateways and to attach to the one or more assets using a user interface module for formatting and displaying the data in response to queries from the user, the data including location and corresponding time stamps

In another embodiment the asset has a destination, and wherein every gateway at the destination is in communication with at least three nodes such that the position of an asset can be triangulated.

### BRIEF DESCRIPTION OF DRAWINGS

FIG. 1 shows the tracking system.

FIG. 2 shows a tracking sensor.

FIG. 3 shows a detailed version of the indoor tracking.

### DETAILED DESCRIPTION OF DRAWINGS

It should be understood that although illustrative implements of one or more embodiments of the present disclosure are provided below, the disclosed systems and/or methods may be implemented using multiple approaches. The disclosure should in no way be limited to the illustrative implementations and drawings included. These implementations and drawings may be modified within the scope of the claims with their full scope of equivalents.

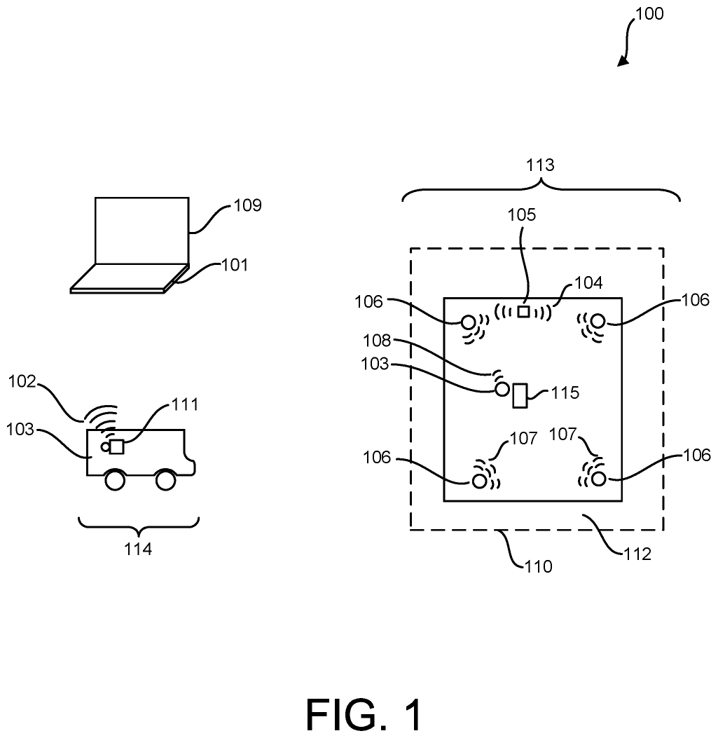

FIG. 1 shows the asset tracking system 100, which allows for centralized monitoring of a plurality of tracking sensors 103. The asset tracking system 100 allows for centralized and seamless monitoring of outdoor tracking 114 as well as indoor tracking 113. When the tracking sensors 103 are outside or otherwise not in range of a plurality of nodes 106 the tracking sensors will determine a location based on the Global Positioning System (GPS) and will transmit data 102 based on its GPS position so that the tracking sensors 103 and an associated outside asset 111 can have their position known. When the tracking is indoors or otherwise in range of the signal from a plurality of nodes 106, then the tracking sensors 103 and the associated inside asset 115 will have their position determined using the triangulated location using radio communication, with the preferred radio communication being Bluetooth Low Energy or a radio communication of around 2.4 GHz frequency, and will transmit indoor data 108. The nodes 106 will have known locations relative to the building to determine location. The nodes 106 will triangulate and communicate 107 to create a mesh network. Typically, a system will include four nodes 106 on each floor of a destination building 112 such as a hospital. Typically, each floor will also have one gateway 105 that will collect data from the tracking sensors 103 which it can communicate through the mesh network of nodes if the tracking sensor 103 is not in range.

The centralized monitoring system is also comprised of a centralized computing device 101 and an interface 109. The centralized computing device has memory and processing capability. The centralized computing device 101 can be the cloud or it can be run locally at the destination. The gateways 105 communicate data 104 to the centralized computing device 101, typically through wireless internet connections. The interface 109 is configured to accept queries from a user and to display responses to such queries. The queries relate to data from tracking sensors and depend upon how the tracking sensor is configured.

Through the interface 109, a user can configure a geofence 110 around a destination 112. The geofence 110 is an electronic boundary generally set up around the perimeter of a building. The geofence 110 can act as a transition between the outdoor tracking 114 and the indoor tracking 113 portions of the asset tracking system 100. Among other benefits, this allows for the tracking sensors to be categorized as “inside” and “outside.”

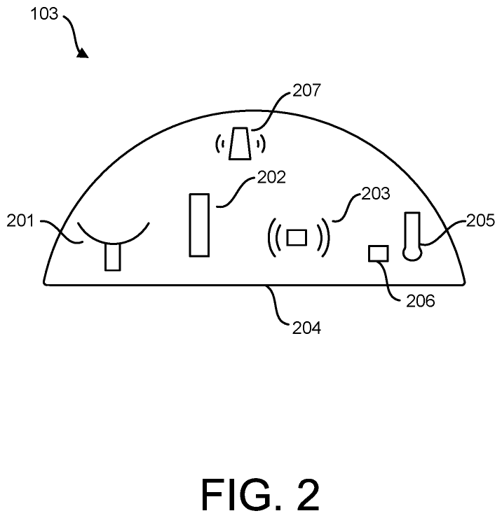

FIG. 2 shows a tracking sensor 103 with sensors, receivers, and transmitters. Each tracking sensor 103 has a GPS receiver 201, a radio receiver 202, a cellular transmitter 207, a radio transmitter 203, memory 206 and a sticky surface 204. The GPS receiver 201 is configured to receive signals from the GPS. In the preferred embodiment, the radio receiver 202 is configured to receive radio frequency of 2.4 GHz for wife and Bluetooth low energy. The radio transmitter is configured to transmit radio signals at 2.4 GHz for short range communication. The cellular transmitter 207 transmits signals to the centralized computing device 101 until the tracking sensor 103 reaches a destination. Memory 206 allows the tracking sensor 103 to store data which is particularly useful when the tracking sensor is out of range of transmitting data to the centralized computing device 101. The tracking sensor 103 may also be equipped with a temperature sensor 205. The sticky surface can be any surface known in the art for attaching a sensor.

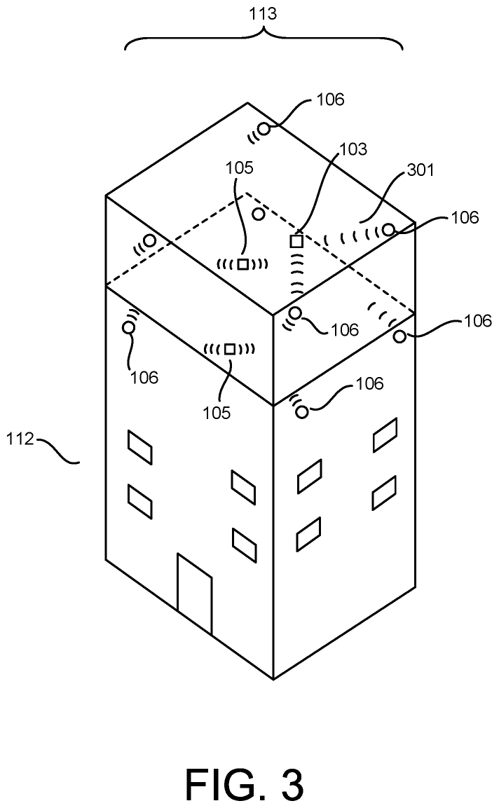

FIG. 3 shows a more detailed illustration of the indoor tracking 113 portion of the asset tracking system 100. Nodes 106 are spaced out at known locations on each floor of a destination 112 such as a hospital. In FIG. 3, the locations of nodes 106 and gateways 105 are shown on the top two floors of a destination 112, such as a hospital. Typically, one gateway 105 is also located on the floor. The tracking sensor 103 is communicating with three nodes 106 such that it can be triangulated 301 so that the position can be determined. This allows for precise location capability.

We claim:

1. An asset tracking system comprising
a centralized computing device configured to receive data from one or more tracking sensors, the tracking sensors configured to communicate with the global positioning system, cellular networks, and a mesh network
the mesh network comprising one or more gateways and a plurality of nodes
the plurality of nodes and the one or more gateways configured to track the one or more tracking sensors
the one or more tracking sensors configured to attach to an asset
an interface in communication with the centralized computing device configured to display location data for any one or more of the one or more tracking sensors
an adjustable geofence module configured to create a perimeter around a destination for the asset, wherein the perimeter can be adjusted via the network interface.

2. The system of claim 1, wherein the gateway is configured to communicate with ethernet, wife, cellular networks, and Bluetooth low energy networks.

3. The system of claim 1, wherein the one or more tracking sensors are configured to send data that includes a temperature of the tracking sensor.

4. The system of claim 1, wherein the interface is configured to accept queries from a user and communicate with the centralized computing device to respond to such queries.

5. The system of claim 1, wherein the adjustable geofence can be monitored by GPS or the mesh network.

6. The system of claim 1, wherein the plurality of nodes communicate with others of the plurality of nodes that are within a range.

7. The system of claim 1, wherein the one or more gateways and the plurality of nodes communicate at a radio frequency that is compatible with Bluetooth low energy mesh systems.

8. The system of claim 1, wherein the tracking sensor further comprise a memory module configured for storing data.

9. An asset tracking system comprising:
a centralized computing system
one or more gateways configured to communicate with one or more nodes, a plurality of tracking sensors and the centralized computing system the plurality of tracking sensors further comprising
a module configured to receive GPS signals
a module configured to receive radio signals
a module configured to transmit radio signals
the radio signals being in range of Bluetooth and wife
a module configured to transmit cellular signals to the centralized computing system
an interface for showing a location for any one of the plurality of tracking sensors.

10. The asset tracking system of claim 9, wherein the interface can receive a query with a question regarding the data acquired from a tracking sensor from a user and return a response to the query.

11. The asset tracking system of claim 9, wherein the gateway is configured to communicate with wifi, ethernet, cellular networks, and Bluetooth low energy networks.

12. The asset tracking system of claim 9, wherein the plurality of tracking sensors provide data in addition to location data, such as temperature data.

13. The asset tracking system of claim 9, wherein the plurality of tracking sensors provide temperature data.

14. The asset tracking system of claim 9, wherein the plurality of tracking sensors are configured to stick to an asset.

15. The asset tracking system of claim 9, wherein the plurality of tracking sensors have a memory module configured to store the data.

16. The asset tracking system of claim 9, further comprising a customizable geofence to surround the perimeter of a destination of an asset.

17. A computer implemented method for tracking one or more assets, the method comprising:
using a centralized computing system to receive cellular or internet data from one or more gateways and a plurality of tracking sensors, the plurality of tracking sensors configured
to communicate the data to
a mesh network of one or more nodes and the one or more gateways or to a cellular network and
to attach to the one or more assets
using a user interface module for formatting and displaying the data in response to queries from the user, the data including location and corresponding time stamps

18. The computer implemented method of claim 17, wherein the tracking sensors have a memory module configured to store the data.

19. The computer implemented method of claim 17, further comprising the step of establishing a geofence around a destination for the asset to provide additional data regarding the asset.

20. The computer implemented method of claim 17, wherein the asset has a destination, and the destination has at least four gateways on each floor of the destination.
